(19) United States
(12) Patent Application Publication
(10) Pub. No.: US 2023/0239009 A1
(43) Pub. Date: Jul. 27, 2023

(54) SYSTEMS AND METHODS FACILITATING INCREASED CAPACITY IN RADIO FREQUENCY (RF) COMMUNICATIONS

(71) Applicant: Joseph Rhyne, Falls Church, VA (US)

(72) Inventor: Joseph Rhyne, Falls Church, VA (US)

(21) Appl. No.: 18/100,779

(22) Filed: Jan. 24, 2023

Related U.S. Application Data
(60) Provisional application No. 63/303,609, filed on Jan. 27, 2022.

(51) Int. Cl. H04B 7/005; H04B 7/08

(52) U.S. Cl. CPC H04B 7/005; H04B 7/0891

(57) ABSTRACT

Systems and methods employing a Radio Frequency (RF) communication link that transmits three or more RF signals in one direction, with each signal carrying its own data stream. The signals share time, frequency and space resources and define polarities separated by a pre-determined, substantially non-orthogonal angle. A Multi-Polarity Interference Cancellation (MPIC) feature removes the multi-channel interference for each distinct channel.

### CROSS-REFERENCE TO RELATED APPLICATION

This application claims the benefit of, and priority to, U.S. Provisional Pat. Application No. 63/303,609, filed on Jan. 27, 2022, the entire contents of which are hereby incorporated herein by reference.

### FIELD

The present disclosure relates to Radio Frequency (RF) communications and, more specifically, to systems and methods facilitating increased capacity in RF communications.

### BACKGROUND

Presently, RF data communication links, e.g., between stationary antennas, utilize two wireless RF signals superimposed in time, space, and frequency, wherein the polarities of the two signals define an orthogonal angle therebetween. This orthogonal polarity angle difference between the two signals allows for the simultaneous transmission of the two signals in the same direction at the same time, space, and frequency, e.g., using Polarization Division Multiplexing (PDM). However, as perfect orthogonality of the polarization angle difference between the two signals is difficult to achieve and maintain, cross-pole interference cancellation (XPIC) may be utilized to minimize errors in the data transmission.

### SUMMARY

The terms “about,” substantially,” and the like, as utilized herein, are meant to account for tolerances and variations, up to and including differences of 10%. Further, to the extent consistent, any of the aspects described herein may be used in conjunction with any or all of the other aspects described herein.

Systems and methods of the present disclosure enable increased capacity of communication in an RF data communication link, e.g., between stationary transmission and receiver antennas, by providing at least three RF signals (N signals, wherein N>=3) superimposed in time, space, and frequency and defining non-orthogonal polarity angles between each signal and the adjacent signal(s) (wherein “adjacent signal(s)” of a particular signal are defined as the signal or signals having the smallest polarity difference from the particular signal). Each signal is transmitted through a different channel (of the corresponding polarity) and is capable of carrying its own data stream. This configuration enables signal polarity to be utilized as the primary discriminator for the at least three signals and, thus, increases the data communication capacity of the RF data communication link proportional to the number of signals according to (N/2*100) - 100. For example, the data communication capacity is increased by 50% where N=3 (as compared to the presently-available two signal communication), and the data communication capacity is increased by 100% where N=4 (as compared to the presently-available two signal communication). This increase in capacity does not require any additional usage of the RF spectrum, with each N channels supporting the same data rate and delivering approximately the same signal quality.

The polarity angle differences between each pair of adjacent signals may be fixed and pre-determined. In aspects, the polarity angle difference between each pair of adjacent signals is substantially non-orthogonal and less than 90 degrees. In aspects, the polarity angle difference between each pair of adjacent signals is defined according to 180/N. In other aspects, the polarity angle difference for at least two adjacent signal pairs is different, such that the polarity angle differences across the plural signals are non-uniform.

The systems and methods of the present disclosure may be configured for use with stationary antennas (transmission antennas, receiver antennas, and/or transceiver antennas) configured to maintain substantially constant polarity isolation between channels (with each corresponding to a different pre-determined polarity). The systems and methods may also employ a multi-channel synchronized RF tuner and/or a Multi-Polarity Interference Cancellation (MPIC) system configured to remove the associated multi-channel interference from each channel. The angle differences between the signals are used as the primary discriminators for the MPIC system to remove cross-channel interference for each distinct channel.

In aspects, the systems and methods of the present disclosure may also be applied, in addition to the RF communication link described above, to a reciprocal RF communication link utilizing a different frequency, thereby enabling at least a six channel two-way communication system.

The systems and methods of the present disclosure may be implemented in an RF wireless communication system and, more specifically, for data communication between first and second fixed base stations or nodes. For example, the first base station may be configured for communication (wireless and/or cable-connected) with a plurality of user devices or user equipment such as, for example, mobile devices, computers, Internet of Things (IoT) devices, etc., and the second base station may be configured for communication with a broader network. The communication between the first and second base stations, according to the systems and methods of the present disclosure, thus enables connection of the plurality of user devices to the broader network.

Although described herein with respect to RF communication systems, other implementations of the disclosure are also contemplated. The systems and methods of the present disclosure may be utilized in varies configurations involving wireless transport including but not limited to microwave communications systems.

### BRIEF DESCRIPTION OF THE DRAWINGS

Various aspects and features of the present disclosure are described hereinbelow with reference to the drawings wherein:

FIG. 1 is a schematic illustration of an RF communication system configured for use in accordance with aspects of the present disclosure;

FIG. 2 is a block diagram illustrating at least some of the operable components of transmission and reception systems of the RF communication system of FIG. 1 to enable communication therebetween in accordance with the present disclosure;

FIG. 3A is a graphical representation of a three-signal configuration in accordance with the present disclosure and configured for use with the RF communication system of FIG. 1 or any other suitable communication system; and

FIG. 3B is a graphical representation of a four-signal configuration in accordance with the present disclosure and configured for use with the RF communication system of FIG. 1 or any other suitable communication system.

### DETAILED DESCRIPTION

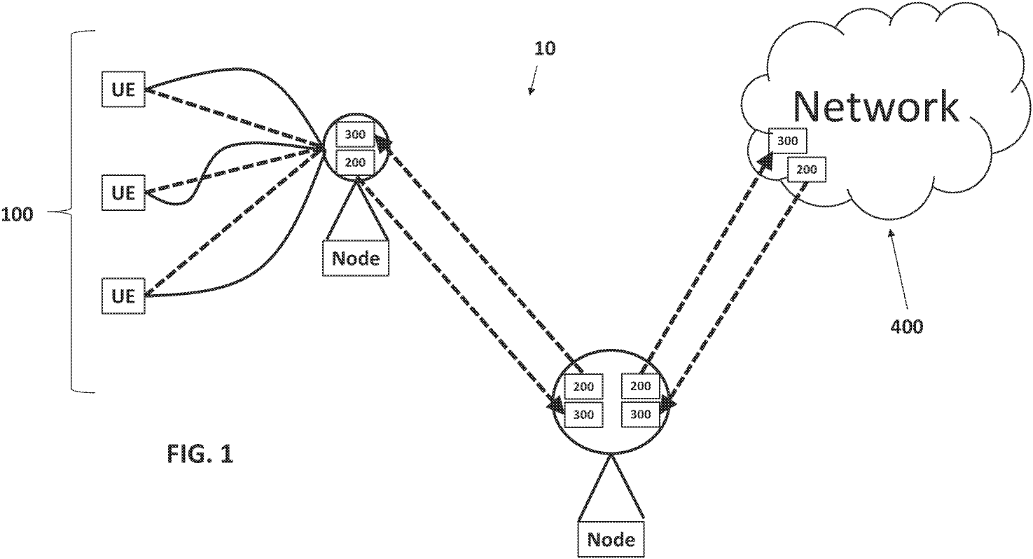

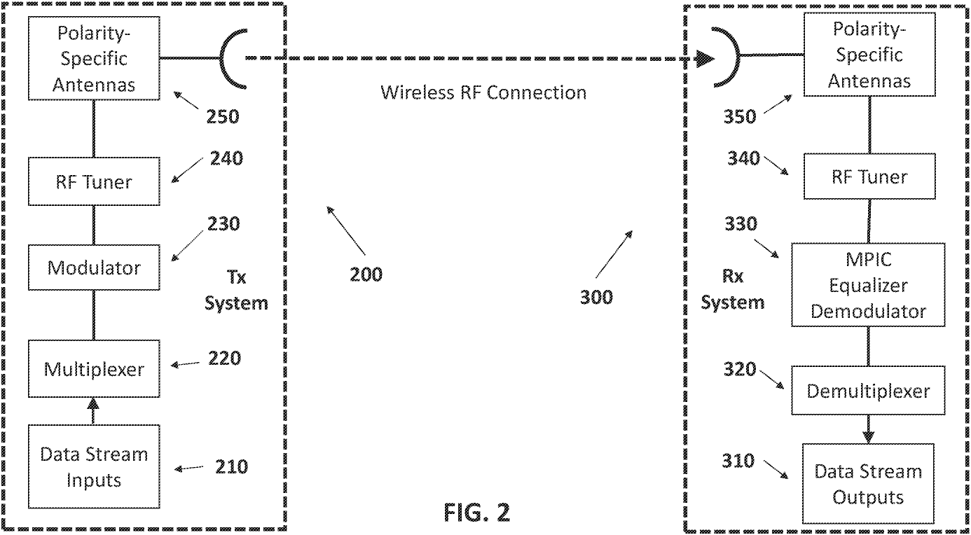

Referring to FIG. 1, an RF communication system configured for use in accordance with aspects of the present disclosure is shown generally identified as system 10. System 10 includes user equipment (UE) 100 configured to communicate wirelessly and/or via a cable connection to a network node. System 10 further includes a network node, which provides two way communications between UE 100 and a broader network 400. UE 100 may include one or more mobile devices, computers, Internet of Things (IoT) devices, intermediate nodes, connection devices, etc. Transmit (Tx) and receive (Rx) systems 200, 300, respectively, are located at each node between UE 100 and network 400 to enable two way communications between UE 100 and network 400, as shown in FIG. 1. In aspects, the nodes and/or UE and associated Tx and Rx systems 200, 300, respectively, thereof may be part of terrestrial, satellite, or airborne communications, or combinations thereof. Satellite communications may include communications between a space vehicle (SV) and a terrestrial UE, another SV and/or an airborne platform (plane or unmanned aerial vehicle). Airborne communications may include communications between an airborne platform and a terrestrial UE, another airborne platform and/or an SV. In aspects, the polarities of the antenna elements 250, 350 (FIG. 2) on the SV, airborne platform and/or terrestrial UE should remain generally static relative to the geometry between the antenna elements 250, 350 (FIG. 2), as detailed below.

Turning to FIG. 2, Tx system 200 receives a plurality of data stream inputs 210 and includes a multiplexer 220, a modulator 230, a RF tuner 240, and a plurality of polarity-specific driven antenna elements 250, henceforth referred to as antenna elements. Multiplexer 220 is configured to receive the plurality of data stream inputs 210, e.g., from UE 100 (FIG. 1), and to combine the data streams into N digital baseband signals, load balancing the data streams across the total capacity of the system’s N channels, and relaying the N baseband signals to modulator 230, with each N signals representing data streams and supporting approximately the same maximum data rate. Modulator 230 converts the received N baseband signals from multiplexer 220 to N analog intermediate frequency (IF) signals. RF tuner 240 receives the N IF signals from modulator 230 and up-coverts the N signals from IF to RF or carrier frequency to support RF transmission. The N RF channels may correspond to the number of data streams to be transmitted simultaneously (sharing time, space, and frequency resources). Modulator 230 may include a plurality of modulators, one for each of the data streams (channels). The plurality of modulators of modulator 230 are synchronized with one another, e.g., using a common reference signal.

RF tuner 240 converts the N IF signals to RF or carrier frequency, as noted above, to support transmission from Tx system 200 to Rx system 300, where N corresponds to the number of data streams the system supports (or, in aspects, a number less than the number of data streams the system supports - for configurations wherein less than all available channels are utilized). RF tuner 240, in aspects, is configured as a phase coherent multi-channel (3+ channels) tuner. In other aspects, RF tuner 240 includes multiple single-channel RF tuners that are phase-synchronized, e.g., using a common reference signal to synchronize channel phase between multiple single-channel RF tuners. In other aspects, RF tuner 240 includes multiple dual-channel phase coherent RF tuners that are phase synchronized between dual-channel tuners using a common reference signal. Other aspects incorporate some combination of the above-mentioned tuners.

The data streams, at the RF frequency, are transmitted from RF tuner 240 via connectors, cabling, and/or amplifiers, to the transmission antenna(s), with each channel corresponding to a polarity-specific antenna element 250. In aspects, the RF tuner 240 (or tuners) along with the cabling, connectors, amplifiers, and/or antenna elements 250 corresponding to each channel (data stream) are generally phase matched. Each antenna element 250 is configured to output one of the data streams at a static, pre-determined polarity, thereby defining a channel. More specifically, the number, N, of polarity-specific antenna elements 250 is greater than or equal to three wherein each antenna element 250 is configured with a static, pre-determined polarity. In aspects, the polarity angle difference between each antenna element 250 and any adjacent antenna elements 250 (defined as the other antenna element(s) 250 with the smallest polarity difference to the antenna element 250) is substantially non-orthogonal and, in aspects, less than 90 degrees. Further, the polarity angle difference between each pair of adjacent antenna elements 250 may be defined according to 180/N. In other aspects, the polarity angle differences for at least two pairs of adjacent antenna elements 250 are different from one another, such that the polarity angle differences across different pairs of adjacent antenna elements 250 are non-uniform. The number of antenna elements 250 corresponds to the number of channels which, in turn, corresponds to the number of data streams to be transmitted simultaneously (sharing time, space, and frequency resources).

As a result of the above-detailed configuration of the polarity-specific antenna elements 250, each data stream is transmitted, as a signal, through an RF communication channel from one of the antenna elements 250 of the Tx system 200 to Rx system 300, wherein the number of signals, N, is greater than or equal to three. The polarities of the different signals are non-orthogonal relative to any adjacent signals and may otherwise be configured similarly as detailed above with respect to the corresponding antenna elements 250.

Continuing with reference to FIG. 2, the signals are received at Rx system 300 via a plurality of polarity-specific driven antenna elements 350, henceforth referred to as antenna elements. More specifically, each antenna element 350 of Rx system 300 corresponds to a matched antenna element 250 of Tx system 200 wherein each matched pair of antenna elements 250, 350 has the same polarity and the antenna elements 250, 350 of each matched pair are aligned to match geometry, resulting in the maximum decibel (DB) polarity isolation between channels. This is further facilitated by configuring the antennas supporting antenna elements 250, 350 to remain static.

Antenna elements 250, 350 may be included in any one of, or combinations of, various different antennas such as, for example, 3+ polarity antennas (wherein the antennas that include antenna elements 250, 350 each consists of single or multiple reflectors married with 3+ antenna elements 250, 350 corresponding to at least three different polarities), 4+ polarity antennas (wherein the antennas that include antenna elements 250, 350 each consists of single or multiple reflectors married with 4+ antenna elements 250, 350 corresponding to at least four different polarities), etc. Antennas incorporating a common-phase-center with the 3+ polarity antenna elements as described above are also contemplated. In other aspects, traditional orthogonal cross-polarized antennas, single polarity antennas, etc. are utilized to achieve the required geometrically aligned antenna elements 250, 350. In other aspects, antenna elements 250, 350 both transmit and receive RF signals as part of systems 200, 300, thereby reducing the total number of antenna elements and associated reflectors required for system 10 (FIG. 1).

The signals received at antenna elements 350 of Rx system 300 are transmitted to RF tuner 340 of Rx system 300 which converts the data streams (at the carrier or RF frequency) to IF signals. RF tuner 340 may be configured similar to RF tuner 240 except operating in reverse. The signals, at the IF, are then transmitted to a sub-system 330 including a Multi-Polarity Interference Cancellation (MPIC) feature, an equalizer, and a demodulator, although separate systems for each are also contemplated. Despite alignment of the matched pairs of antenna elements 250, 350 and isolation of the polarities thereof, some amount of signal mixing between channels typically occurs as the RF signals travel between the antenna elements 250, 350. Thus, the removal of multi-channel interference is necessary to avoid significant degradation of signal quality, which may result in limited or no data transmission.

The MPIC of sub-system 330 may employ a polarization division multiplexing technique to nullify non-target channel interference present in each target channel, where the antenna elements 250, 350 of each matched pair are optimally aligned (as noted above). More specifically, for each N target channels, an adaptive, closed-loop MPIC feature may be employed to vary the phase and amplitude of the N-1 interfering non-target channels and combine the optimal phase and amplitude adjusted N-1 interfering signals with each target channel in order to maximize the demodulated signal quality of the target channel, thereby nullifying non-target channel interference present in the target channel.

For scenarios where the antenna elements 250, 350 of each matched pair are not optimally aligned, the MPIC feature isolates the target channels present in non-target channels and combines the signals in order to maximize the demodulated signal quality of each target channel. In aspects, signal separation, and the destructive and constructive combining are combined into a single stage.

Operating in series or in combination with the MPIC feature described above, the equalizer feature may be adaptive, multi-tap, and designed to mitigate complex frequency response impairments (amplitude and phase versus frequency) of each polarity-specific channel caused in many instances by multipath fading. In aspects, the use of a closed-loop receive-site IF and/or baseband multi-tap adaptive equalizer(s) that are adjusted to maximize the signal quality of each dynamic RF channel as measured by the demodulated signal quality for each polarity specific channel may be employed. Alternatively or additionally, closed-loop baud rate and carrier recovery may be optimized based on demodulated signal quality for each polarity-specific channel. A transmit site pre-equalizer, e.g., of Tx system 200, optimized based on feedback from the receive-site equalizer, e.g., of Rx system 300, may also be provided. Similar to modulator 230, sub-system 330 may include a plurality of sub-systems 330, one for each of the data streams (channels). The plurality of sub-systems of sub-system 330 are synchronized with one another, e.g., using a common reference signal.

The sub-system 330, after completing MPIC, equalization, and demodulation functions, transmits the N data streams via digital baseband to the demultiplexer 320 which separates the aggregate baseband signals into output data streams 310 for use at the site of the node including Rx system 300 and/or onward transmission to another network node or, for example, the broader network 400 (FIG. 1).

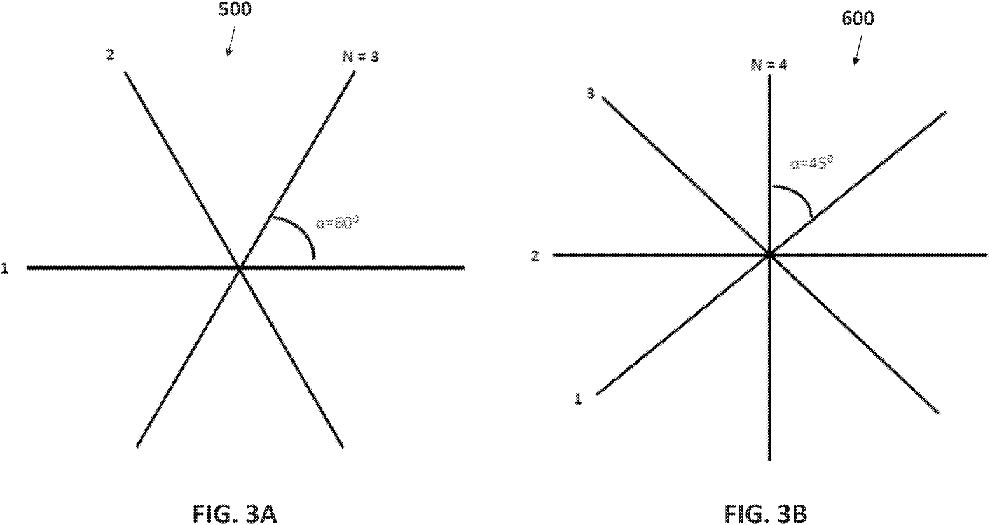

Turning to FIG. 3A, a three-channel, three-signals, or three data stream configuration is shown as configuration 500, wherein each of the channels, signals, or data streams defines a polarity difference of 60 degrees with respect to any adjacent channel, signal, or data stream. For example, the first, second, and third channels, signals, or data streams may define polarities of 0 degrees, 60 degrees, and 120 degrees. However, non-uniform or other polarity angle differences are also contemplated.

With reference to FIG. 3B, a four-channel, four-signals, or four data stream configuration is shown as configuration 600, wherein each of the channels, signals, or data streams defines a polarity difference of 45 degrees with respect to any adjacent channel, signal, or data stream. For example, the first, second, third, and fourth channels, signals, or data streams may define polarities of 0 degrees, 45 degrees, 90 degrees, and 135 degrees. However, non-uniform or other polarity angle differences are also contemplated.

It will be understood that various modifications may be made to the aspects and features disclosed herein. Therefore, the above description should not be construed as limiting, but merely as exemplifications of various aspects and features. Those skilled in the art will envision other modifications within the scope and spirit of the claims appended thereto.

What is claimed is:

1. A Radio Frequency (RF) communication system, comprising:
a transmit (Tx) system including at least first, second, and third transmission antenna elements configured to output at least first, second, and third wireless RF signals at different predetermined, non-orthogonal polarities respectively, thereby defining at least first, second, and third communication channels; and
a receive (Rx) system including at least first, second, and third receiver antenna elements defining at least first, second, and third matched pairs of antenna elements with the respective at least first, second, and third transmission antenna elements, the transmission and receiver antenna elements of each matched pair aligned with one another and of the same polarity, the at least first, second, and third receiver antenna elements configured to receive the at least first, second, and third wireless RF signals of the at least first, second, and third communication channels.

2. The RF communication system according to claim 1, wherein the Rx system further includes a sub-system having a multi-polarity interference cancellation feature configured to remove multi-channel interference from each of the at least first, second, and third communication channels, the multi-polarity interference cancellation feature utilizing each channel’s polarity as the primary discriminating factor.

3. The RF communication system according to claim 2, wherein each of the Tx and Rx systems further includes an RF tuner operatively coupled to the respective at least first, second, and third transmission and receiver antenna elements.

4. The RF communication system according to claim 3, wherein each RF tuner includes:
multiple RF tuners that are phase synchronized across channels using a reference signal;
a multiple channel RF tuner that is phase coherent between channels; or
a combination of phase coherent and phase synchronized tuners.

5. The RF communication system according to claim 3, wherein the sub-system further includes a demodulator and an equalizer.

6. The RF communication system according to claim 5, wherein the sub-system further includes a demultiplexer operatively coupled to an output of the sub-system.

7. The RF communication system according to claim 1, wherein the Tx system further includes:
an input configured to receive a plurality of data streams; and
a multiplexer configured to combine the plurality of data streams for transmission through the at least first, second, and third communication channels.

8. The RF communication system according to claim 7, wherein the Tx system further includes a modulator to convert the at least first, second, and third data streams from baseband to intermediate frequency (IF) and an RF tuner configured to up-convert the at least first, second, and third data streams from IF to RF.

9. The RF communication system according to claim 1, wherein the Rx system is configured to receive data streams from user equipment.

10. The RF communication system according to claim 1, wherein the Rx system is configured to receive the at least first, second, and third wireless RF signals from the Tx system to facilitate connectivity with at least one of: a broader network or other network nodes.

11. A Radio Frequency (RF) communication method, comprising:
transmitting at least first, second, and third wireless RF signals at different predetermined, non-orthogonal polarities respectively, thereby defining at least first, second, and third communication channels; and
receiving the at least first, second, and third wireless RF signals of the at least first, second, and third communication channels.

12. The RF communication method according to claim 11, further comprising:
removing multi-channel interference from each of the at least first, second, and third communication channels with respect to the received at least first, second, and third wireless RF signals, respectively.

13. The RF communication method according to claim 11, further comprising, prior to transmitting the at least first, second, and third wireless RF signals, up-converting the at least first, second, and third wireless RF signals to an RF frequency.

14. The RF communication method according to claim 13, further comprising down-converting the received at least first, second, and third wireless RF signals to a baseband frequency.

15. The RF communication method according to claim 11, wherein the transmitting occurs at a transmit (Tx) system and wherein the receiving occurs at a receive (Rx) system.

16. The RF communication method according to claim 15, further comprising:
receiving, at the Rx system, a plurality of data streams from which the first, second, and third wireless RF signals are generated.

17. The RF communication method according to claim 16, further comprising:
transmitting, from the Tx system, a plurality of data streams based upon the first, second, and third wireless RF signals.

18. The RF communication method according to claim 11, wherein the transmitting is performed by at least first, second, and third transmitting antenna elements at the Tx system, and wherein the receiving is performed by at least first, second, and third receiver antenna elements at the Rx system.

19. The RF communication method according to claim 11, wherein the at least first, second, and third transmitting antenna elements and the respective at least first, second, and third receiving antenna elements define at least first, second, and third matched pairs of antenna elements, and wherein the antenna elements in each matched pair of antenna elements are aligned with one another and of equal polarity.

20. The RF communication method according to claim 11, wherein the at least first, second, and third wireless RF signals are transmitted simultaneously in time, space, and frequency.
